(19) United States
(12) Patent Application Publication
(10) Pub. No.: US 2017/0027109 A1
(43) Pub. Date: Feb. 2, 2017

(54) GROW LIGHT MATRIX SYSTEM

(71) Applicant: Douglas H. Powell, Eldorado Hills, CA (US)

(72) Inventor: Douglas H. Powell, Eldorado Hills, CA (US)

(21) Appl. No.: 14/810,182

(22) Filed: Jul. 27, 2015

(51) Int. Cl. A01G 7/04; A01G 9/20

(52) U.S. Cl. CPC A01G 7/045; A01G 9/20

(57) ABSTRACT

A lighting system for stimulating plant growth. The system includes two or more plants in a grow area. The system also includes an array of light fixtures. The light fixtures in the array of light fixtures are positioned vertically such that at least a portion of each of the light fixtures is at or below the top of the two or more plants. The light fixtures in the array of light fixtures are also located such that each plant is exposed to the light from at least two of the light fixtures. The light fixtures in the array of light fixtures are further arranged in a flanking pattern around each plant. At least one of the light fixtures is positioned between at least two of the two or more plants.

### CROSS-REFERENCE TO RELATED APPLICATIONS

Not applicable.

### BACKGROUND OF THE INVENTION

Photosynthesis is a process used by plants and other organisms to convert light energy, normally from the Sun, into chemical energy that can be later released to fuel the organisms' activities. This chemical energy is stored in carbohydrate molecules, such as sugars, which are synthesized from carbon dioxide and water—hence the name photosynthesis, from the Greek φ\tilde{ω}ζ, phōs, “light”, and σ\acute{υ}vθεσιζ, synthesis, “putting together.” In most cases, oxygen is also released as a waste product. Most plants, most algae, and cyanobacteria perform photosynthesis; such organisms are called photoautotrophs. Photosynthesis maintains atmospheric oxygen levels and supplies all of the organic compounds and most of the energy necessary for life on Earth.

Although photosynthesis is performed differently by different species, the process always begins when energy from light is absorbed by proteins called reaction centers that contain green chlorophyll pigments. In plants, these proteins are held inside organelles called chloroplasts, which are most abundant in leaf cells. In these light-dependent reactions, some energy is used to strip electrons from suitable substances, such as water, producing oxygen gas. Furthermore, two further compounds are generated: reduced nicotinamide adenine dinucleotide phosphate (NADPH) and adenosine triphosphate (ATP), the “energy currency” of cells.

In plants, algae and cyanobacteria, sugars are produced by a subsequent sequence of light-independent reactions called the Calvin cycle, but some bacteria use different mechanisms, such as the reverse Krebs cycle. In the Calvin cycle, atmospheric carbon dioxide is incorporated into already existing organic carbon compounds, such as ribulose bisphosphate (RuBP). Using the ATP and NADPH produced by the light-dependent reactions, the resulting compounds are then reduced and removed to form further carbohydrates, such as glucose.

However, in nature the amount of photosynthesis that can occur within a single plant is limited. In particular, many of the green areas of a plant do not receive light throughout the entire day. This is due to a number of factors, including the rotation of the earth which changes the location of the sun relative to the plant. Therefore, the plant itself sometimes shades itself.

However, there are not any mechanisms to bypass photosynthesis. I.e., there aren't any processes that allow for conversion of electricity directly into biological molecules. Therefore, the only mechanism for stimulating plant growth with inadequate sunlight is to use power to produce light which is then used by the plants for photosynthesis. However, many of these systems suffer from the same drawbacks outlined above. I.e., they place lights above the plants. Therefore, the highest leaves in the plants cast shadows on lower leaves, leaving a portion of the plant which does not photosynthesize.

Accordingly, there is a need in the art for a system which can stimulate the growth of plants by maximizing the surface of the plant which is receiving light and, therefore, participating in photosynthesis. Additionally, there is a need in the art for a system which makes as much produced light as possible available for photosynthesis.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a lighting system for stimulating plant growth. The system includes two or more plants in a grow area. The system also includes an array of light fixtures. The light fixtures in the array of light fixtures are positioned vertically such that at least a portion of each of the light fixtures is at or below the top of the two or more plants. The light fixtures in the array of light fixtures are also located such that each plant is exposed to the light from at least two of the light fixtures. The light fixtures in the array of light fixtures are further arranged in a flanking pattern around each plant. At least one of the light fixtures is positioned between at least two of the two or more plants.

Another example embodiment includes a lighting system for stimulating plant growth. The system includes two or more plants in a grow area. The system also includes an array of light fixtures. The light fixtures in the array of light fixtures are positioned vertically such that at least a portion of each of the light fixtures is at or below the top of the two or more plants. The light fixtures in the array of light fixtures are also located such that each plant is exposed to the light from at least two of the light fixtures. The light fixtures in the array of light fixtures are further arranged in a flanking pattern around each plant. The light fixtures in the array of light fixtures additionally provide 360 degrees of light to each of the two or more plants. At least one of the light fixtures is located between at least two of the two or more plants and provides light to at least two of the two or more plants.

Another example embodiment includes a method for arranging plants and light fixtures to stimulate plant growth. The method includes placing two or more plants in a grow area. The method also includes placing an array of light fixtures. The light fixtures in the array of light fixtures are positioned vertically such that at least a portion of each of the light fixtures is at or below the top of the two or more plants. The light fixtures in the array of light fixtures are also located such that each plant is exposed to the light from at least two of the light fixtures. The light fixtures in the array of light fixtures are further arranged in a flanking pattern around each plant. At least one of the light fixtures is located between at least two of the two or more plants and provides light to at least two of the two or more plants. The method further includes providing power to the light fixtures according to a predetermined schedule.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a top view of the example of a grow light matrix system;

FIG. 1B illustrates a side view of the example of a grow light matrix system;

FIG. 1C illustrates a front view of the example of a grow light matrix system;

FIG. 1D illustrates a perspective view of the example of a grow light matrix system;

FIG. 2 illustrates an example of a light fixture configured as a vertical rod;

FIG. 3A illustrates a top view of the example of a linear matrix;

FIG. 3B illustrates a perspective view of the example of a linear matrix;

FIG. 4A illustrates a top view of the example of a triangle matrix 400;

FIG. 4B illustrates a perspective view of the example of a triangle matrix;

FIG. 5A illustrates a top view of the example of a square matrix;

FIG. 5B illustrates a perspective view of the example of a square matrix; and

FIG. 6 is a flow chart illustrating a method 600 for arranging plants and light fixtures to stimulate plant growth.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

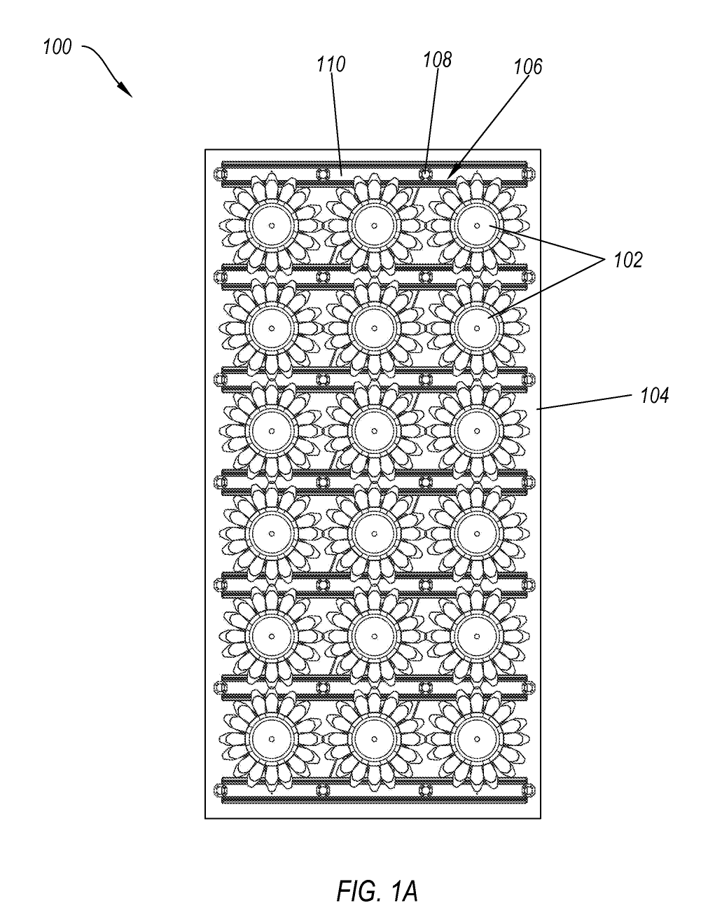

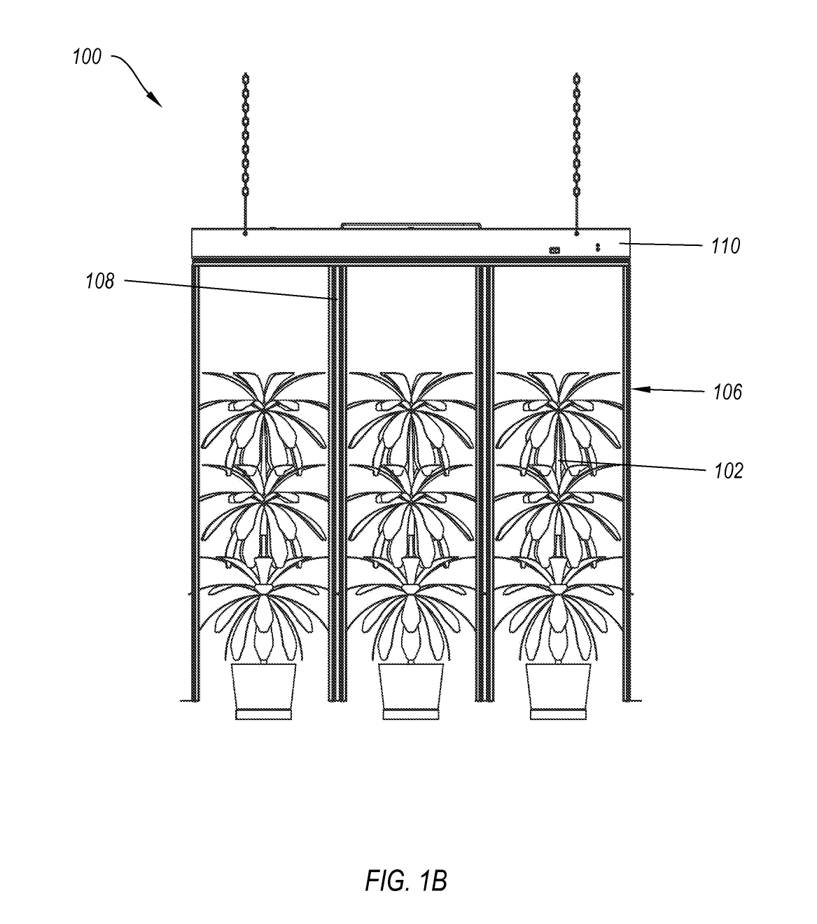

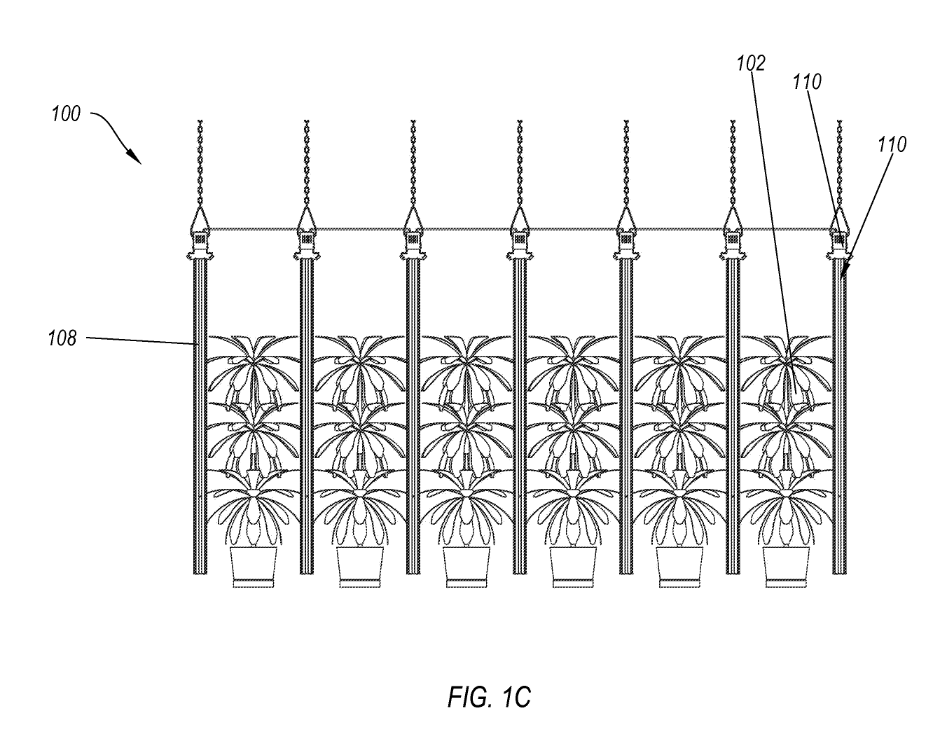

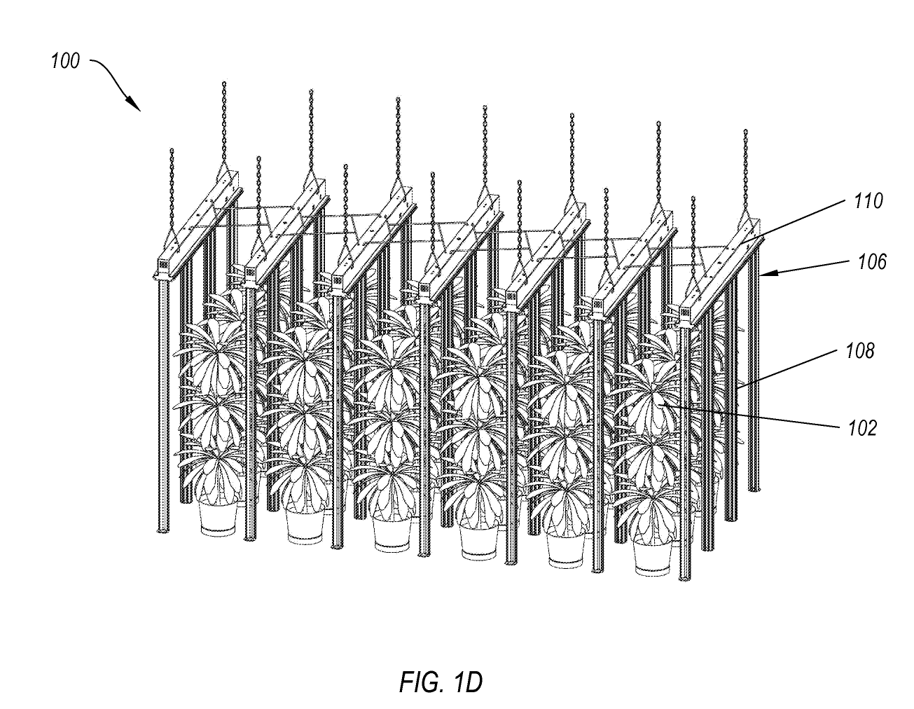

FIGS. 1A, 1B, 1C and 1D (collectively “FIG. 1”) illustrate an example of a grow light matrix system 100. FIG. 1A illustrates a top view of the example of a grow light matrix system 100; FIG. 1B illustrates a side view of the example of a grow light matrix system 100; FIG. 1C illustrates a front view of the example of a grow light matrix system 100; and FIG. 1D illustrates a perspective view of the example of a grow light matrix system 100. The system 100 stimulates the growth potential of the plants. In particular, light is delivered to the plants in a manner that allows all photosynthesizing surfaces to receive light which allows the plant to reach greater growth. The grow light matrix system 100 can be arranged in different patterns depending on the light penetration desired within the plants.

FIG. 1 shows that the system 100 can include two or more plants 102. The plants 102, also called green plants (Viridiplantae in Latin), are multicellular eukaryotes of the kingdom Plantae. They form a clade that includes the flowering plants, conifers and other gymnosperms, ferns, clubmosses, hornworts, liverworts, mosses and the green algae. Plants 102 exclude the red and brown algae, the fungi, archaea, bacteria and animals. Green plants 102 have cell walls with cellulose and characteristically obtain most of their energy from sunlight via photosynthesis by primary chloroplasts, derived from endosymbiosis with cyanobacteria. Their chloroplasts contain chlorophylls a and b which gives them their green color. Plants 102 are also characterized by sexual reproduction, modular and indeterminate growth, and an alternation of generations, although asexual reproduction is also common. The two or more plants 102 can be arranged in any desired pattern. For example, FIG. 1 shows the two or more plants 102 arranged in 3 by 6 grid. Other patterns, such as a 4 by 8 grid, may also be achieved.

FIG. 1 also shows that the two or more plants 102 are located in a grow area 104. The grow area 104 can include any area that is configured to receive the two or more plants 102. For example, the grow area 104 can include a garden bed, a series of pots, a water tank (such as for aquaponics or hydroponics) or any other area that can receive the two or more plants 102. The grow area 104 can include one or more features that allow for controlling the environment around the two or more plants 102. For example, the grow area 104 can be located in a grow house which includes a building or housing that separates the grow area from the surrounding environment. That is, the grow house can include walls, roofs or other structures that prevent the outside weather from having an effect on the environment of the grow area 104.

FIG. 1 further shows that the system 100 can include an array of light fixtures 106. The array of light fixtures 106 includes a number of individual light fixtures 108 that are intended to stimulate growth of the plants 102. For example, the light fixtures 108 should have a high enough intensity to that the plants 102 can photosynthesize. Additionally or alternatively, the light fixtures 108 should be low temperature fixtures 108, such as LEDs and compact fluorescents, otherwise they can overheat and damage the plants 102. The light fixtures 108 can be arranged in any desired pattern. For example, FIG. 1 shows the light fixtures 108 arranged in 4 by 7 grid. Other patterns, such as a 5 by 9 grid, may also be achieved.

For example, FIG. 1 shows that the light fixtures can include one or more vertical rods. That is, each light fixture is a rod that radiates light laterally in all directions. This means that light reaches the plants 102 from multiple directions.

In order to stimulate growth of the plants 102, the light fixtures 108 are positioned by the array of light fixtures 106 vertically such that at least a portion of each of the light fixtures 108 is at or below the top of the two or more plants 102. That is, at least some of the light emitting portion of the light fixture is below the top of each of the two or more plants 102. This allows the light to both reach leaves that are below the top of the plant, leaves which would receive little or no light in either a natural environment or a grow area with only overhead lights, and allows light to reach the bottom of upper leaves, which increases the photosynthesizing surface of the two or more plants 102.

Likewise, the light fixtures 108 are located such that each plant is exposed to the light from at least two of the light fixtures 108 and are arranged in a flanking pattern around each plant. This further increases the surface area of the two or more plants 102 which is photosynthesizing. In particular, the light fixtures 108 may provide 360 degrees of light to each of the two or more plants. This allows many of the plants “green” surfaces to continually photosynthesize, whereas in a natural environment some or all green surfaces are, at various times, not exposed to light and photosynthesis cannot occur. Moreover, at least one of the light fixtures 108 is located between at least two of the two or more plants 102 and provides light to at least two of the two or more plants. A flanking pattern means that the light fixtures 108 are to the side of each of the two or more plants 102. In particular, a flanking pattern as used herein means to place a light fixture 108 on each side of the two or more plants 102 such that the light fixtures 108 substantially surround each of the two or more plants 102. The flanking pattern may or may not be symmetrical about each of the two or more plants 102 in a horizontal plane.

Having two or more plants 102 can be critical to maximize the use of light by the plants 102. That is, since many light fixtures 108 will radiate light in multiple directions it is critical for the light fixtures 108 to supply light to more than one plant 102. I.e., efficiency is maximized when as much light as possible from each light fixture reaches a plant 102. Therefore, having two or more plants 102 allows for greater efficiency as a greater percentage of light fixtures 108 are stimulating growth in multiple plants 102.

FIG. 1 also shows that the system 100 can include one or more supports 110. The supports 110 are configured to allow the array of light fixtures 106 to be hung from a ceiling. That is, the supports 110 hang the array of light fixtures 106 in the configuration described above. Additionally or alternatively, the supports 110 can supply power to the array of light fixtures 106. For example, the supports 110 can include a ballast or other power source. An electrical ballast is a device intended to limit the amount of current in an electric circuit. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

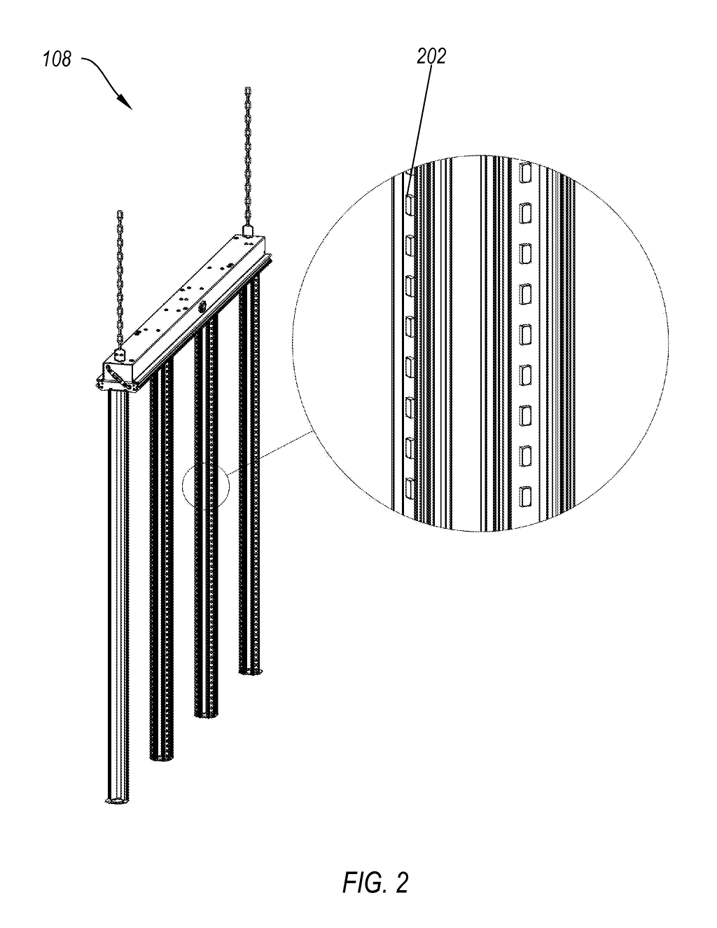

FIG. 2 illustrates an example of a light fixture 108 configured as a vertical rod. That is, the light fixture 108 acts as a vertical rod even though it is not explicitly a vertical rod. Thus, the light fixture 108 provides the benefits of a vertical rod, such as 360 degrees of light in a horizontal plane, without the need to build a vertical rod.

FIG. 2 shows that the light fixture 108 can include a vertical light bar 202. The vertical light bar 202 is a series of lights arranged in a linear fashion. However, the lights do not emit light through all 360 degrees of the horizontal plane. For example, the light may only be emitted through 90 degrees or 120 degrees of the horizontal plane. Therefore, three or four light bars 202 arranged around a common center can be used to approximate a vertical rod.

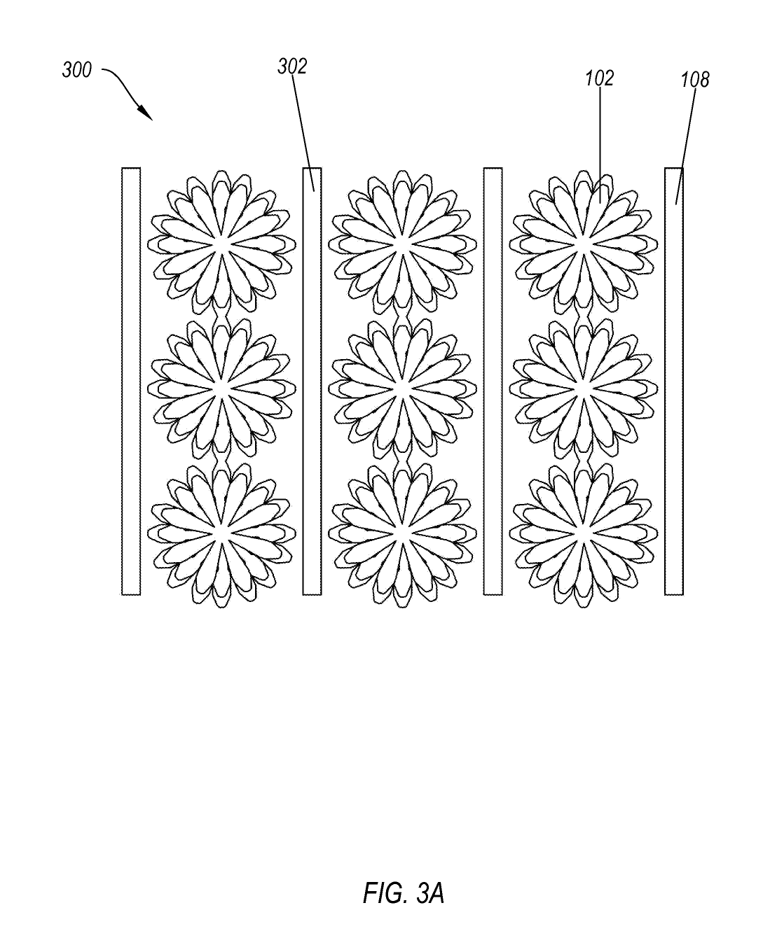

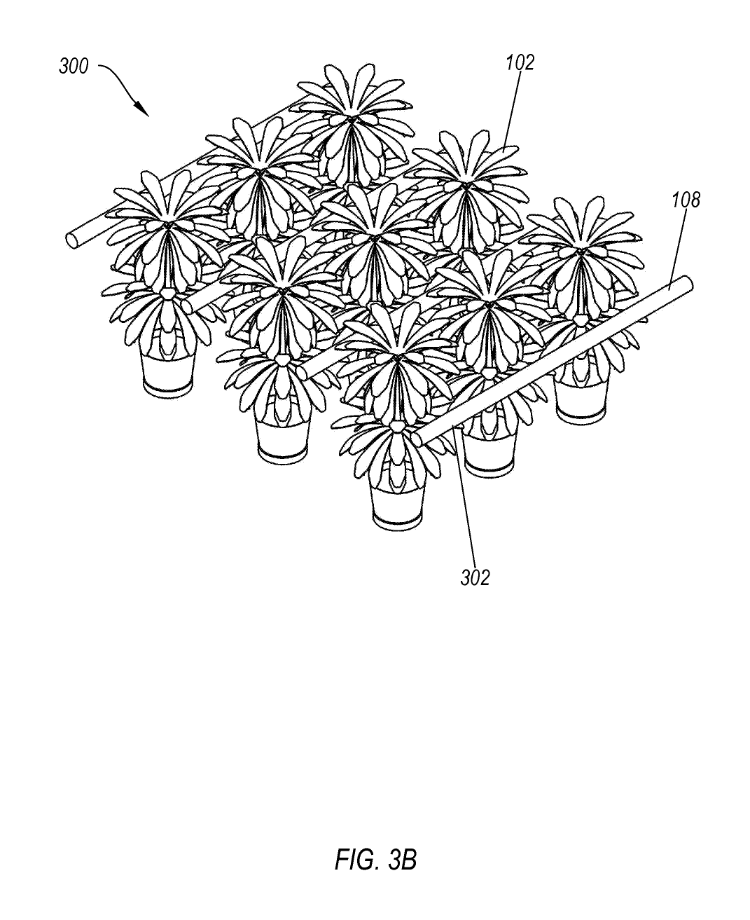

FIGS. 3A and 3B (collectively “FIG. 3”) illustrate an example of a linear matrix 300. FIG. 3A illustrates a top view of the example of a linear matrix 300; and FIG. 3B illustrates a perspective view of the example of a linear matrix 300. A linear matrix is an arrangement of the two or more plants 102 in a line with the light fixtures 108 directly in between the plants 102 and at the end of each line. That is, the plants 102 and light fixtures 108 form a straight line with one another. The linear matrix can be signified using the notation [light fixture-plant]ₙ-light fixture, wherein n is any positive integer greater than 2.

FIG. 3 shows that the linear matrix 300 can include one or more horizontal rods 302. That is, each light fixture is a rod that radiates light in all vertical directions. This means that light reaches the plants 102 from multiple directions. The horizontal rods 302 can include linear lights configured as a horizontal rod, as described above in FIG. 2 with regard to vertical rods.

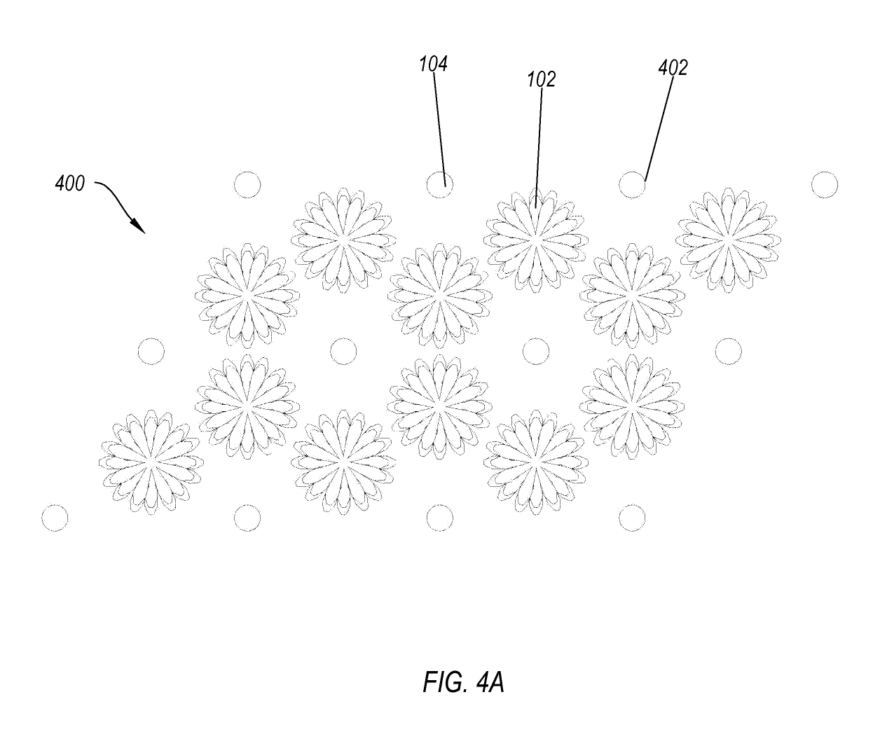

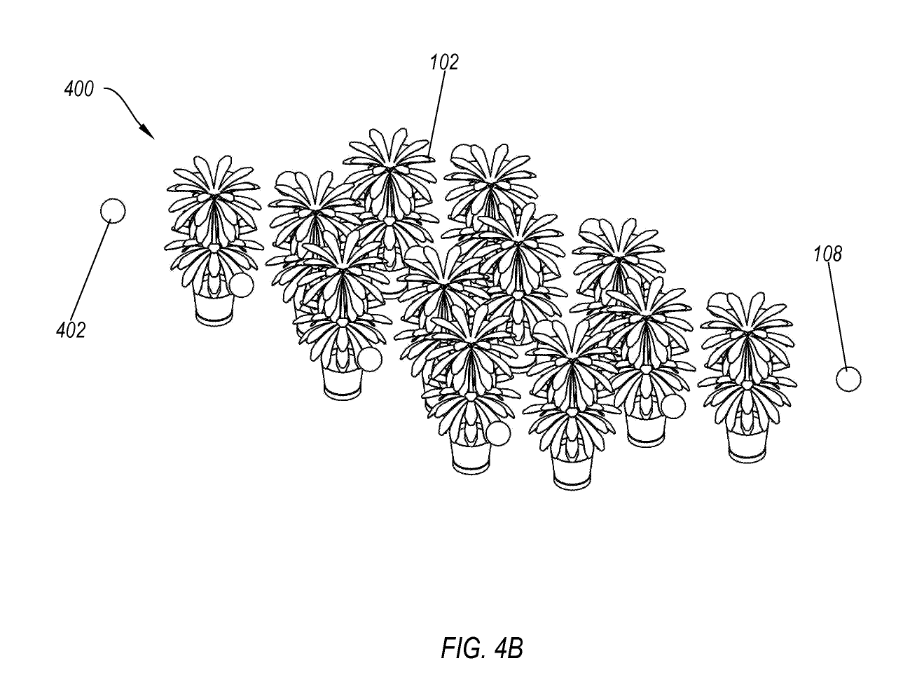

FIGS. 4A and 4B (collectively “FIG. 4”) illustrate an example of a triangle matrix 400. FIG. 4A illustrates a top view of the example of a triangle matrix 400; and FIG. 4B illustrates a perspective view of the example of a triangle matrix 400. A triangle matrix is an arrangement of the two or more plants 102 such that each plant has exactly three light fixtures 1018 arranged about the plant 102. That is, the light fixtures 108 form a triangle surrounding each the plants 102. To maximize the number of plants 102 within the grow area the triangle matrix can include plants arranged in a hexagonal pattern with a light fixture 108 at the center of each hexagon.

FIG. 4 shows that the triangle matrix 400 can include one or more globe lights 402. That is, each light fixture 108 radiates in all directions in a spherical pattern. Globe lights 402 can be used to ensure that as many green surfaces of the plants 102 can be photosynthesizing. This means that light reaches the plant 102 from multiple directions.

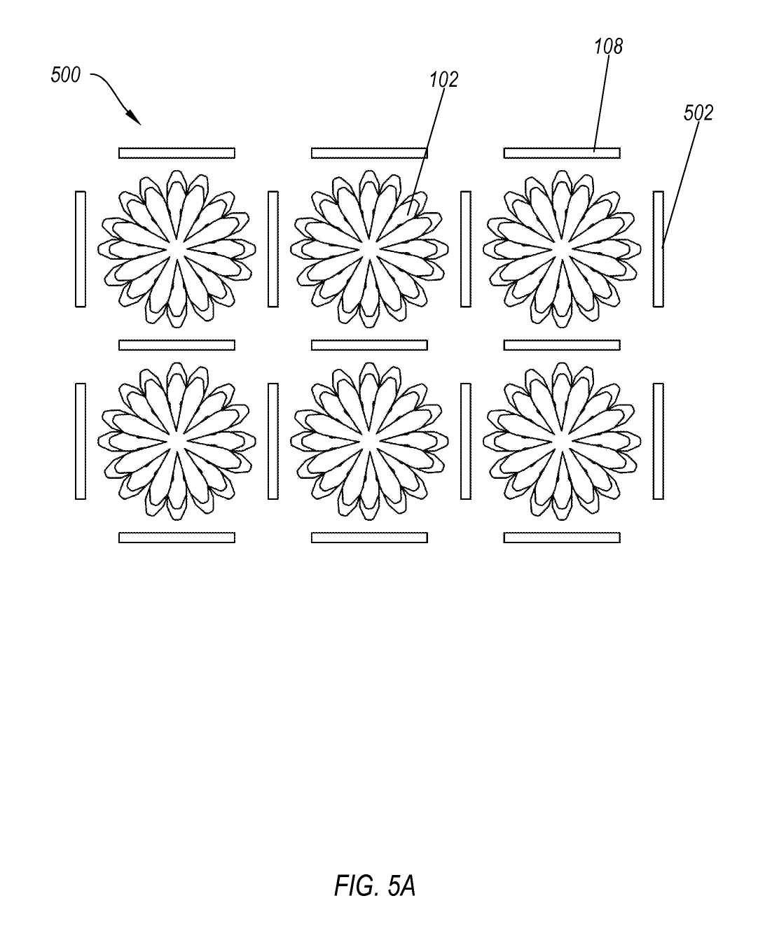

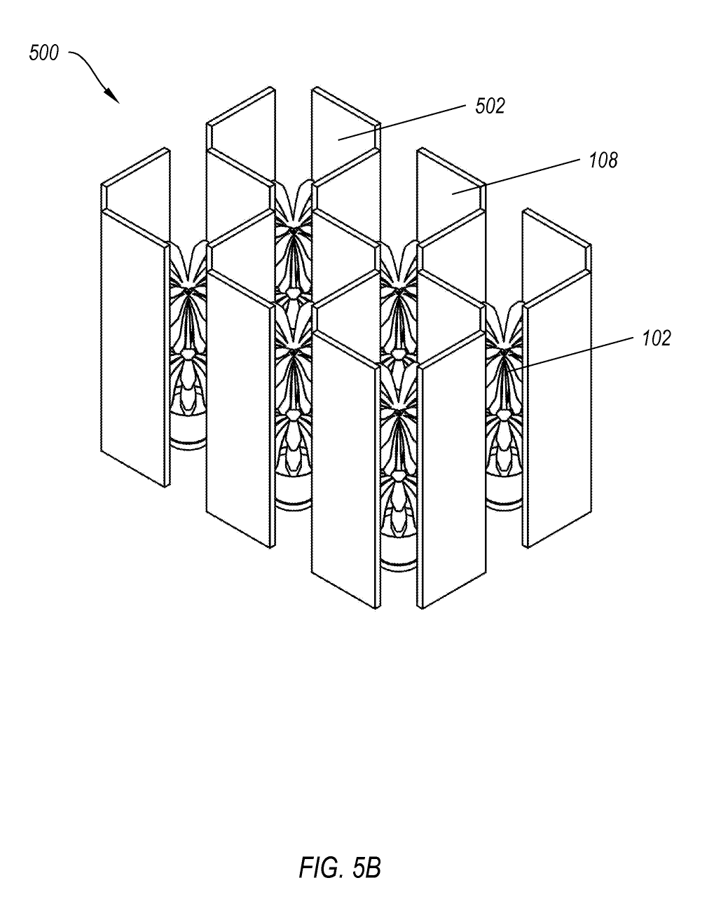

FIGS. 5A and 5B (collectively “FIG. 5”) illustrate an example of a square matrix 500. FIG. 5A illustrates a top view of the example of a square matrix 500; and FIG. 5B illustrates a perspective view of the example of a square matrix 500. A square matrix is an arrangement of the two or more plants 102 with four light fixtures 108 arranged around each plant 102. For example, the square matrix 500 can include a line with the light fixtures 108 directly in between the plants 102 and at the end of each line and between the rows of plants 102. I.e., a square matrix 500 can include multiple linear matrices with light fixtures between plants 102 in adjoining rows of plants 102. That is, the plants 102 and light fixtures 108 form a square line with one another.

FIG. 5 shows that the linear matrix 500 can include one or more panel lights 502. That is, each light fixture 108 is a flat sheet placed where one or more surfaces of the sheet radiate light used by the two or more plants for photosynthesis. Panel lights 502 can be used to ensure that more light is radiating linearly from the light fixture 108. That is, arranging the light fixture 108 as a panel allows for most radiation of light to occur in two opposite horizontal directions whereas the perpendicular directions receive little or no light. This means that light reaches the plant from two or more directions (but may not surround the plant 360 degrees).

One of skill in the art will appreciate that different light fixtures may be used with different matrices than the examples used herein. For example, the linear matrix 300 of FIG. 3 may be used with globes lights, vertical rods, panel lights or any other desired light fixture. Likewise, horizontal rods 302 of FIG. 3 may be used with a triangle matrix, square matrix or any other desired plant arrangement.

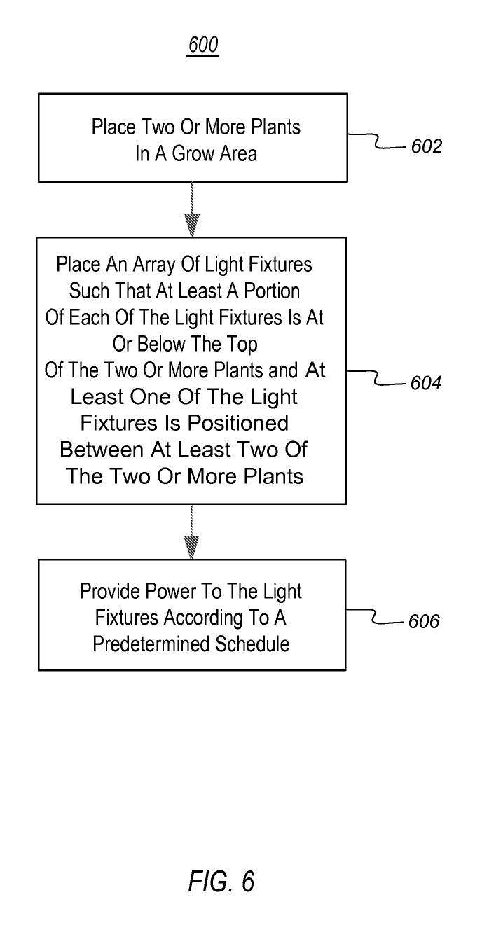

FIG. 6 is a flow chart illustrating a method 600 for arranging plants and light fixtures to stimulate plant growth. In at least one implementation, the arrangement of plants and light fixtures can include the grow light matrix system 100 of FIGS. 1-4. Therefore, the method 600 will be described, exemplarily, with reference to the grow light matrix system 100 of FIGS. 1-4. Nevertheless, one of skill in the art can appreciate that the method 600 can be used with an arrangement other than the grow light matrix system 100 of FIGS. 1-4.

FIG. 6 shows that the method 600 can include placing 602 two or more plants in a grow area. The grow area can include any area that is configured to receive the two or more plants. For example, the grow area can include a garden bed, a series of pots, a water tank (such as for aquaponics or hydroponics) or any other area that can receive the two or more plants. The grow area can include one or more features that allow for controlling the environment around the two or more plants. For example, the grow area can be located in a grow house which includes a building or housing that separates the grow area from the surrounding environment. That is, the grow house can include walls, roofs or other structures that prevent the outside weather from having an effect on the environment of the grow area.

FIG. 6 also shows that the method 600 can include placing 604 an array of light fixtures such that at least a portion of each of the light fixtures is at or below the top of the two or more plants and at least one of the light fixtures is positioned between at least two of the two or more plants. The array of light fixtures includes a number of individual light fixtures that are intended to stimulate growth of the plants. For example, the light fixtures should have a high enough intensity to that the plants can photosynthesize. Additionally or alternatively, the light fixtures should be low temperature fixtures, such as LEDs and compact fluorescents; otherwise they can overheat and damage the plants.

For example, the light fixtures can include one or more vertical rods. That is, each light fixture is a rod that radiates light in all horizontal directions. This means that light reaches the plants from multiple directions.

In order to stimulate growth of the plants, the light fixtures are positioned by the array of light fixtures vertically such that at least a portion of each of the light fixtures is at or below the top of the two or more plants. That is, at least some of the light emitting portion of the light fixture is below the top of each of the two or more plants. This allows the light to both reach leaves that are below the top of the plant, leaves which would receive little or no light in either a natural environment or a grow area with only overhead lights, and allows light to reach the bottom of upper leaves, which increases the photosynthesizing surface of the two or more plants.

Likewise, the light fixtures are located such that each plant is exposed to the light from at least two of the light fixtures and are arranged in a flanking pattern around each plant. This further increases the surface area of the two or more plants which is photosynthesizing. In particular, the light fixtures may provide 360 degrees of light to each of the two or more plants. This allows many of the plants “green” surfaces to continually photosynthesize, whereas in a natural environment some or all green surfaces are, at various times, not exposed to light and photosynthesis cannot occur.

Having two or more plants can be critical to maximize the use of light by the plants. That is, since many light fixtures will radiate light in multiple directions it is critical for the light fixtures to supply light to more than one plant. I.e., efficiency is maximized when as much light as possible from each light fixture reaches a plant. Therefore, having two or more plants allows for greater efficiency as a greater percentage of light fixtures are stimulating growth in multiple plants.

The system can include one or more supports. The supports are configured to allow the array of light fixtures to be hung from a ceiling. That is, the supports hang the array of light fixtures in the configuration described above. Additionally or alternatively, the supports can supply power to the array of light fixtures. For example, the supports can include ballast or other power source. Electrical ballast is a device intended to limit the amount of current in an electric circuit.

FIG. 6 additionally shows that the method include providing 606 power to the light fixtures according to a predetermined schedule. Providing 606 power to the light fixtures allows them to produce light which can be used by the plants for photosynthesis. Additionally or alternatively, some plants need rest periods. I.e., the plants need periods where they are not receiving light. Therefore the predetermined schedule can include one or more “rest” periods where the light fixtures are turned off and the plants are not photosynthesizing.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A lighting system for stimulating plant growth, the system comprising:
three or more plants in a grow area, wherein:
the centers of least three of the three or more plants are not substantially coincident to a line located on any plane; and
an array of light fixtures, wherein:
the light fixtures in the array of light fixtures:
are positioned vertically such that at least a portion of each of the light fixtures is below the top of the three or more plants;
are located such that each plant is exposed to the light from at least two of the light fixtures;
are arranged in a flanking pattern around each plant; and
at least one of the light fixtures is positioned between at least two of the three or more plants.

2. The system of claim 1, wherein:
the three or more plants include 18 plants arranged in a 3 by 6 grid; and
the array of light fixtures includes 28 light fixtures in a 4 by 7 grid.

3. The system of claim 1, wherein:
the three or more plants include 32 plants arranged in a 4 by 8 grid; and
the array of light fixtures includes 45 light fixtures in a 5 by 9 grid.

4. The system of claim 1, wherein the light fixtures in the array of light fixtures are configured as vertical rods of light.

5. The system of claim 1, wherein the light fixtures in the array of light fixtures are configured as horizontal rods of light.

6. The system of claim 1, wherein the light fixtures in the array of light fixtures are configured as panels of light.

7. The system of claim 1 wherein the light fixtures in the array of light fixtures are configured as globes of light.

8. The system of claim 1, wherein each of the lights in each of the light fixtures in the array of light fixtures are LEDs.

9. The system of claim 1, wherein each of the lights in each of the light fixtures in the array of light fixtures are compact fluorescents.

10. The system of claim 1, wherein each of the lights in each of the light fixtures in the array of light fixtures are each low temperature lights.

11. A lighting system for stimulating plant growth, the system comprising:
three or more plants in a grow area, wherein:
the centers of least three of the three or more plants are not substantially coincident to a line located on any plane; and
an array of light fixtures, wherein:
each of the light fixtures in the array of light fixtures:
are positioned vertically such that at least a portion of each of the light fixtures is at or below the top of the three or more plants;
are located such that each plant is exposed to the light from at least two of the light fixtures;
are arranged in a flanking pattern around each plant;
provide 360 degrees of light to each of the three or more plants; and
at least one of the light fixtures:
is located between at least two of the three or more plants; and
provides light to at least two of the three or more plants.

12. The system of claim 11 in a grow house, the grow house comprising:
a housing, the housing configured to create an environment conducive to the growth of the three or more plants;
the grow area, the grow area configured to receive the three or more plants.

13. The system of claim 12, wherein:
the light fixtures are arranged symmetrically about each of the three or more plants.

14. The system of claim 11 further comprising:
a support, the support configured to suspend at least one of the light fixtures in the array of light fixtures; and
provide power to the at least one light fixture.

15. A method for arranging plants and light fixtures to stimulate plant growth, the method comprising:
placing three or more plants in a grow area, wherein:
the centers of least three of the three or more plants are not substantially coincident to a line located on any plane; and
placing an array of light fixtures, wherein:
each of the light fixtures in the array of light fixtures:
are positioned vertically such that at least a portion of each of the light fixtures is at or below the top of the three or more plants;
are located such that each plant is exposed to the light from at least two of the light fixtures;
are arranged in a flanking pattern about each plant; and
at least one of the light fixtures:
is located between at least two of the three or more plants; and
provides light to at least two of the three or more plants; and
providing power to the light fixtures according to a predetermined schedule.

16. The method of claim 15, wherein the light fixtures are organized in a linear matrix.

17. The method of claim 15, wherein the light fixtures are organized in a triangle matrix.

18. The method of claim 15, wherein the light fixtures are organized in a square matrix.

19. The method of claim 15, wherein the predetermined schedule includes at least one rest period per day.

20. The system of claim 1, wherein:
the three or more plants include 8 plants arranged in a 2 by 4 grid; and
the array of light fixtures includes 15 light fixtures in a 3 by 5 grid.

21. The system of claim 1, wherein:
the three or more plants include 4 plants arranged in a 2 by 2 grid; and
the array of light fixtures includes 9 light fixtures in a 3 by 3 grid.

22. The system of claim 1, wherein:
the three or more plants include 9 plants arranged in a 3 by 3 grid; and
the array of light fixtures includes 16 light fixtures in a 4 by 4 grid.
